(19) United States
(12) Patent Application Publication
(10) Pub. No.: US 2013/0002865 A1
(43) Pub. Date: Jan. 3, 2013

(54) MODE REMOVAL FOR IMPROVED MULTI-MODAL BACKGROUND SUBTRACTION

(75) Inventors: Peter Jan Pakulski, Marsfield (AU); Amit Kumar Gupta, Liberty Grove (AU)

(73) Assignee: CANON KABUSHIKI KAISHA, Tokyo (JP)

(21) Appl. No.: 13/534,842

(22) Filed: Jun. 27, 2012

(30) Foreign Application Priority Data
Jun. 30, 2011 (AU) 2011203219

(51) Int. Cl. G06K 9/68; H04N 5/228; H04N 7/18; G06K 9/34

(52) U.S. Cl. 348/143; 382/173; 382/218; 348/222.1; 348/E05.031; 348/E07.085

(57) ABSTRACT

A method and system for updating a visual element model of a scene model associated with a scene, the visual element model including a set of mode models for a visual element for a location of the scene. The method receives an incoming visual element of a frame of the image sequence and, for each mode model, classifies the respective mode model as either a matching mode model or a distant mode model, by comparing an appearance of the incoming visual element and a set of visual characteristics of the respective mode model. The method removes a distant mode model from the visual element model, based upon a first temporal characteristic of a matching mode model exceeding a maturity threshold and a second temporal characteristic of the distant mode model being below a stability threshold.

### REFERENCE TO RELATED PATENT APPLICATION(S)

This application claims priority under 35 U.S.C. §119 from Australian Patent Application No. 2011203219, filed Jun. 30, 2011, which is hereby incorporated by reference in its entirety as if fully set forth herein.

### FIELD OF THE INVENTION

The present disclosure relates to background-subtraction for foreground detection in images and, in particular, to the maintenance of a multi-appearance background model for an image sequence.

### DESCRIPTION OF BACKGROUND ART

A video is a sequence of images, which can also be called a video sequence or an image sequence. The images are also referred to as frames. The terms ‘frame’ and ‘image’ are used interchangeably throughout this specification to describe a single image in an image sequence. An image is made up of visual elements, for example pixels, or 8×8 DCT (Discrete Cosine Transform) blocks, as used in JPEG images.

Scene modelling, also known as background modelling, involves the modelling of the visual content of a scene, based on an image sequence depicting the scene. Scene modelling allows a video analysis system to distinguish between transient foreground objects and the non-transient background, through a background-differencing operation.

One approach to scene modelling represents each location in the scene with a discreet number of mode models in a visual element model, wherein each mode model has an appearance. That is, each location in the scene is associated with a visual element model in a scene model associated with the scene. Each visual element model includes a set of mode models. In the basic case, the set of mode models includes one mode model. In a multi-mode implementation, the set of mode models includes at least one mode model and may include a plurality of mode models. Each location in the scene corresponds to a visual element in each of the incoming video frames. In some existing techniques, a visual element is a pixel value. In other techniques, a visual element is a DCT (Discrete Cosine Transform) block. Each incoming visual element from the video frames is matched against the set of mode models in the corresponding visual element model at the corresponding location in the scene model. If the incoming visual element is sufficiently similar to an existing mode model, then the incoming visual element is considered to be a match to the existing mode model. If no match is found, then a new mode model is created to represent the incoming visual element. In some techniques, a visual element is considered to be background if the visual element is matched to an existing mode model in the visual element model, and foreground otherwise. In other techniques, the status of the visual element as either foreground or background depends on the properties of the mode model to which the visual element is matched. Such properties may include, for example, the “age” of the visual element model.

Multi-mode-model techniques have significant advantages over single-mode-model systems, because multi-mode-model techniques can represent and compensate for recurring appearances, such as a door being open and a door being closed, or a status light that cycles between being red, green, and turned-off. As described above, multi-visual-element-model techniques store a set of mode models in each visual element model. An incoming visual element model is then compared to each mode model in the visual element model corresponding to the location of the incoming visual element.

A particular difficulty of multi-visual-element model approaches however, is over-modelling. As time passes, more and more mode models are created at the same visual element location, until any incoming visual elements are recognised and considered to be background, because similar appearances have been seen at the same location previously. Processing time increases, and memory requirements are increased, as a result of storing an ever-increasing number of mode models. More importantly, some visual elements are considered to be background even if those visual elements correspond to new and previously-unseen objects in the video, but have a similar visual appearance to any other previously visible objects in the history.

One approach to overcoming this difficulty is to limit the number of stored mode models in a visual element model for a given visual element of a scene to a fixed number, K, for example 5. The optimal value of K will be different for different scenes and different applications.

Another known approach is to give each mode model a limited lifespan, or an expiry time. Known approaches set the expiry time depending on how many times a mode model has been matched, or when the mode model was created, or the time at which the mode model was last matched. In all cases, however, there is a trade-off between the speed of adapting to appearances that semantically are changes to the background, and allowing for appearances that semantically are foreground objects.

Thus, a need exists to provide an improved method and system for maintaining a scene model for use in foreground-background separation of an image sequence.

### SUMMARY

It is an object of the present invention to overcome substantially, or at least ameliorate, one or more disadvantages of existing arrangements.

According to a first aspect of the present disclosure, there is provided a method of updating a visual element model of a scene model associated with a scene captured in an image sequence, the visual element model including a set of mode models for a visual element corresponding to a location of the scene. The method receives an incoming visual element of a current frame of the image sequence and, for each mode model in the visual element model, classifies the respective mode model as one of a matching mode model and a distant mode model, dependent upon a comparison between an appearance of the incoming visual element and a set of visual characteristics of the respective mode model. The method then removes a distant mode model from the visual element model, based upon a first temporal characteristic of a matching mode model exceeding a maturity threshold and a second temporal characteristic of the distant mode model being below a stability threshold.

According to a second aspect of the present disclosure, there is provided a computer readable storage medium having recorded thereon a computer program for directing a processor to execute a method of updating a visual element model of a scene model associated with a scene captured in an image sequence, the visual element model including a set of mode models for a visual element corresponding to a location of the scene. The computer program comprises code for performing the steps of: receiving an incoming visual element of a current frame of the image sequence; for each mode model in the visual element model, classifying the respective mode model as one of a matching mode model and a distant mode model, dependent upon a comparison between an appearance of the incoming visual element and a set of visual characteristics of the respective mode model; and removing a distant mode model from the visual element model, based upon a first temporal characteristic of a matching mode model exceeding a maturity threshold and a second temporal characteristic of the distant mode model being below a stability threshold.

According to a third aspect of the present disclosure, there is provided a camera system for capturing an image sequence. The camera system includes: a lens system; a sensor; a storage device for storing a computer program; a control module coupled to each of the lens system and the sensor to capture the image sequence; and a processor for executing the program. The program includes computer program code for updating a visual element model of a scene model associated with a scene captured in an image sequence, the visual element model including a set of mode models for a visual element corresponding to a location of the scene, the updating including the steps of: receiving an incoming visual element of a current frame of the image sequence; for each mode model in the visual element model, classifying the respective mode model as one of a matching mode model and a distant mode model, dependent upon a comparison between an appearance of the incoming visual element and a set of visual characteristics of the respective mode model; and removing a distant mode model from the visual element model, based upon a first temporal characteristic of a matching mode model exceeding a maturity threshold and a second temporal characteristic of the distant mode model being below a stability threshold.

According to a fourth aspect of the present disclosure, there is provided a method of performing video surveillance of a scene by utilising a scene model associated with the scene, the scene model including a plurality of visual elements, wherein each visual element is associated with a visual element model that includes a set of mode models. The method comprises the steps of: updating a visual element model of the scene model by: receiving an incoming visual element of a current frame of the image sequence; for each mode model in the visual element model, classifying the respective mode model as one of a matching mode model and a distant mode model, dependent upon a comparison between an appearance of the incoming visual element and a set of visual characteristics of the respective mode model; and removing a distant mode model from the visual element model, based upon a first temporal characteristic of a matching mode model exceeding a maturity threshold and a second temporal characteristic of the distant mode model being below a stability threshold.

According to a fifth aspect of the present disclosure, there is provided a method of updating a visual element model of a scene model associated with a scene captured in an image sequence, the visual element model including a plurality of mode models for a visual element corresponding to a location of the scene, each mode model being associated with an expiry time. The method includes the steps of: receiving an incoming visual element of a current video frame of the image sequence; for each mode model in the visual element model, classifying the respective mode model as one of a matching mode model and a distant mode model, based upon a comparison between visual characteristics of the incoming visual element and visual characteristics of the respective mode model; reducing the expiry time of an identified distant mode model, dependent upon identifying a matching mode model having a first temporal characteristic exceeding a maturity threshold and identifying a distant mode model having a second temporal characteristic not exceeding a stability threshold, to update the visual element model.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects of the invention are also disclosed.

### BRIEF DESCRIPTION OF THE DRAWINGS

One or more embodiments of the present disclosure will now be described with reference to the following drawings, in which:

FIG. 1 is a functional block diagram of a camera, upon which foreground/background segmentation is performed;

FIG. 2 is a schematic block diagram representation of an input frame, and a scene model consisting of visual element models, which in turn consist of mode models;

FIG. 3 is a flow diagram illustrating a process for matching an input image element to a visual element model;

FIG. 4 shows five frames from an input video, and three corresponding visual element models at a single visual element location, demonstrating the problem with current approaches;

FIG. 5 demonstrates one example of the problem solved, by showing six frames from a long video in which similar appearances at a set of visual element locations eventually cause a failed detection;

FIG. 6 is a flow diagram illustrating a method of the deletion of models;

FIG. 7 illustrates the effect of an embodiment of the present disclosure with reference to the six frames of FIG. 5;

FIGS. 8A and 8B form a schematic block diagram of a general purpose computer system upon which arrangements described can be practised; and

FIG. 9 shows the same five frames as FIG. 4, demonstrating the solution to the current problem.

### DETAILED DESCRIPTION

Where reference is made in any one or more of the accompanying drawings to steps and/or features that have the same reference numerals, those steps and/or features have for the purposes of this description the same function(s) or operation(s), unless the contrary intention appears.

The present disclosure provides a method and system for maintaining a scene model associated with a scene depicted in an image sequence. The method functions by selectively removing from a scene model those elements which may otherwise cause side-effects. In particular, the method is adapted to remove from a visual element model those mode models corresponding to foreground when a mode model corresponding to background is matched to an incoming visual element.

The present disclosure provides a method of updating a visual element model of a scene model. The scene model is associated with a scene captured in an image sequence. The visual element model includes a set of mode models for a visual element corresponding to a location of the scene. The method receives an incoming visual element of a current frame of the image sequence.

In one arrangement, the method, for each mode model in the visual element model, classifies the respective mode model as one of a matching mode model and a distant mode model. The classification is dependent upon a comparison between an appearance of the incoming visual element and a set of visual characteristics of the respective mode model. In one implementation, the appearance of the incoming visual element is provided by a set of incoming visual characteristics associated with the incoming visual element. The method then removes from the visual element model one of the mode models that has been classified as a distant mode model, based upon a first temporal characteristic of a matching mode model exceeding a maturity threshold and a second temporal characteristic of the distant mode model being below a stability threshold.

In another arrangement, the method, for each mode model in the visual element model, classifies the respective mode model as one of a matching mode model and a distant mode model. The classification is based upon a comparison between visual characteristics of the incoming visual element and visual characteristics of the respective mode model. The method then reduces the expiry time of an identified distant mode model, dependent upon identifying a matching mode model having a first temporal characteristic exceeding (i.e. being older than) a maturity threshold and identifying a distant mode model having a second temporal characteristic.

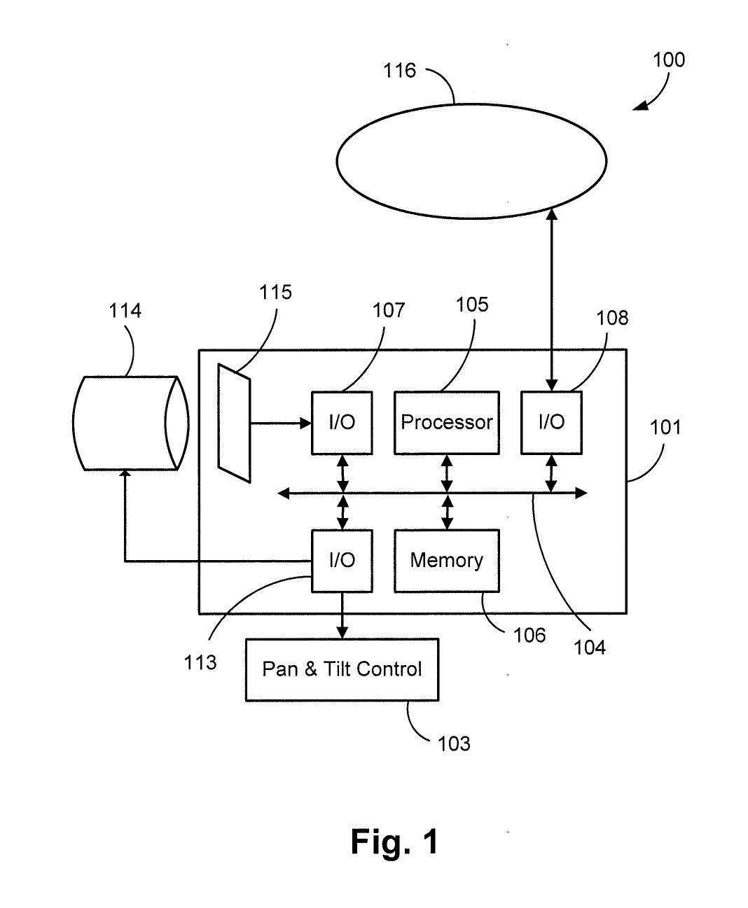

FIG. 1 shows a functional block diagram of a camera 100, upon which foreground/background segmentation may be performed. The camera 100 is a pan-tilt-zoom camera (PTZ) comprising a camera module 101, a pan and tilt module 103, and a lens system 114. The camera module 101 typically includes at least one processor unit 105, a memory unit 106, a photo-sensitive sensor array 115, an input/output (I/O) interface 107 that couples to the sensor array 115, an input/output (I/O) interface 108 that couples to a communications network 116, and an input/output (I/O) interface 113 for the pan and tilt module 103 and the lens system 114. The components 107, 105, 108, 113, and 106 of the camera module 101 typically communicate via an interconnected bus 104 and in a manner that results in a conventional mode of operation known to those in the relevant art.

The camera 100 is used to capture video frames, also known as input images, representing the visual content of a scene, wherein at least a portion of the scene appears in the field of view of the camera 100. Each frame captured by the camera 100 comprises more than one visual element. A visual element is defined as an image sample. In one embodiment, the visual element is a pixel, such as a Red-Green-Blue (RGB) pixel. In another embodiment, each visual element comprises a group of pixels. In yet another embodiment, the visual element is an 8 by 8 block of transform coefficients, such as Discrete Cosine Transform (DCT) coefficients as acquired by decoding a motion-JPEG frame, or Discrete Wavelet Transformation (DWT) coefficients as used in the JPEG-2000 standard. The colour model is YUV, where the Y component represents the luminance, and the U and V represent the chrominance.

In one arrangement, the memory unit 106 stores a computer program that includes computer code instructions for effecting a method for maintaining a scene model in accordance with the present disclosure, wherein the instructions can be executed by the processor unit 105. In an alternative arrangement, one or more input frames captured by the camera 100 are processed by a video analysis system on a remote computing device, wherein the remote computing device includes a processor for executing computer code instructions for effecting a method for maintaining a scene model in accordance with the present disclosure.

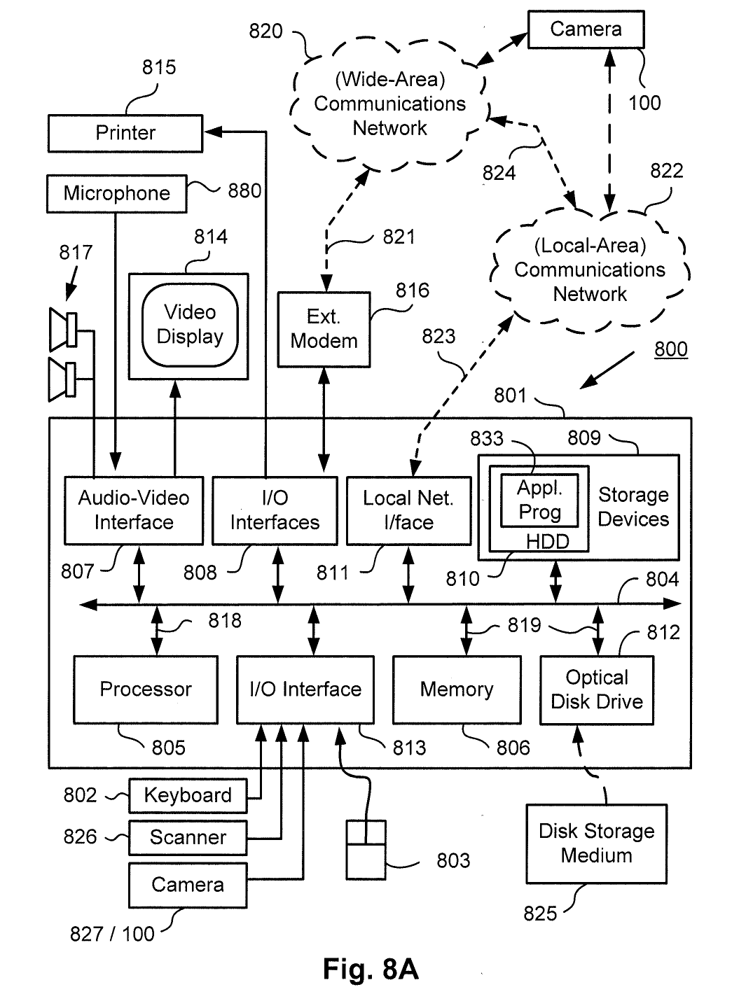

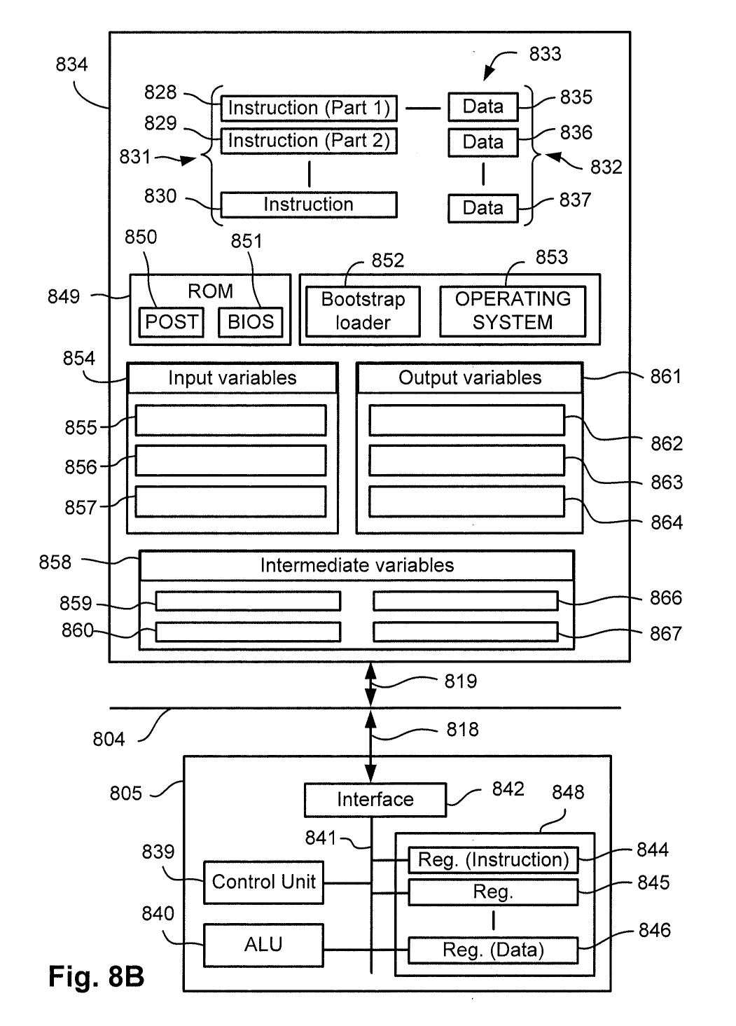

FIGS. 8A and 8B depict a general-purpose computer system 800, upon which the various arrangements described can be practised.

As seen in FIG. 8A, the computer system 800 includes: a computer module 801; input devices such as a keyboard 802, a mouse pointer device 803, a scanner 826, a camera 827, and a microphone 880; and output devices including a printer 815, a display device 814 and loudspeakers 817. An external Modulator-Demodulator (Modem) transceiver device 816 may be used by the computer module 801 for communicating to and from a communications network 820 via a connection 821. The communications network 820 may be a wide-area network (WAN), such as the Internet, a cellular telecommunications network, or a private WAN. Where the connection 821 is a telephone line, the modem 816 may be a traditional “dial-up” modem. Alternatively, where the connection 821 is a high capacity (e.g., cable) connection, the modem 816 may be a broadband modem. A wireless modem may also be used for wireless connection to the communications network 820.

The computer module 801 typically includes at least one processor unit 805, and a memory unit 806. For example, the memory unit 806 may have semiconductor random access memory (RAM) and semiconductor read only memory (ROM). The computer module 801 also includes an number of input/output (I/O) interfaces including: an audio-video interface 807 that couples to the video display 814, loudspeakers 817 and microphone 880; an I/O interface 813 that couples to the keyboard 802, mouse 803, scanner 826, camera 827 and optionally a joystick or other human interface device (not illustrated); and an interface 808 for the external modem 816 and printer 815. In some implementations, the modem 816 may be incorporated within the computer module 801, for example within the interface 808. The computer module 801 also has a local network interface 811, which permits coupling of the computer system 800 via a connection 823 to a local-area communications network 822, known as a Local Area Network (LAN). As illustrated in FIG. 8A, the local communications network 822 may also couple to the wide network 820 via a connection 824, which would typically include a so-called “firewall” device or device of similar functionality. The local network interface 811 may comprise an Ethernet™ circuit card, a Bluetooth™ wireless arrangement or an IEEE 802.11 wireless arrangement; however, numerous other types of interfaces may be practised for the interface 811.

The camera 827 may correspond to the PTZ camera 100 of FIG. 1. In an alternative arrangement, the computer module 801 is coupled to the camera 100 via the Wide Area Communications Network 820 and/or the Local Area Communications Network 822.

The I/O interfaces 808 and 813 may afford either or both of serial and parallel connectivity, the former typically being implemented according to the Universal Serial Bus (USB) standards and having corresponding USB connectors (not illustrated). Storage devices 809 are provided and typically include a hard disk drive (HDD) 810. Other storage devices such as a floppy disk drive and a magnetic tape drive (not illustrated) may also be used. An optical disk drive 812 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 800.

The components 805 to 813 of the computer module 801 typically communicate via an interconnected bus 804 and in a manner that results in a conventional mode of operation of the computer system 800 known to those in the relevant art. For example, the processor 805 is coupled to the system bus 804 using a connection 818. Likewise, the memory 806 and optical disk drive 812 are coupled to the system bus 804 by connections 819. Examples of computers on which the described arrangements can be practised include IBM-PCs and compatibles, Sun Sparcstations, Apple Mac™ or alike computer systems.

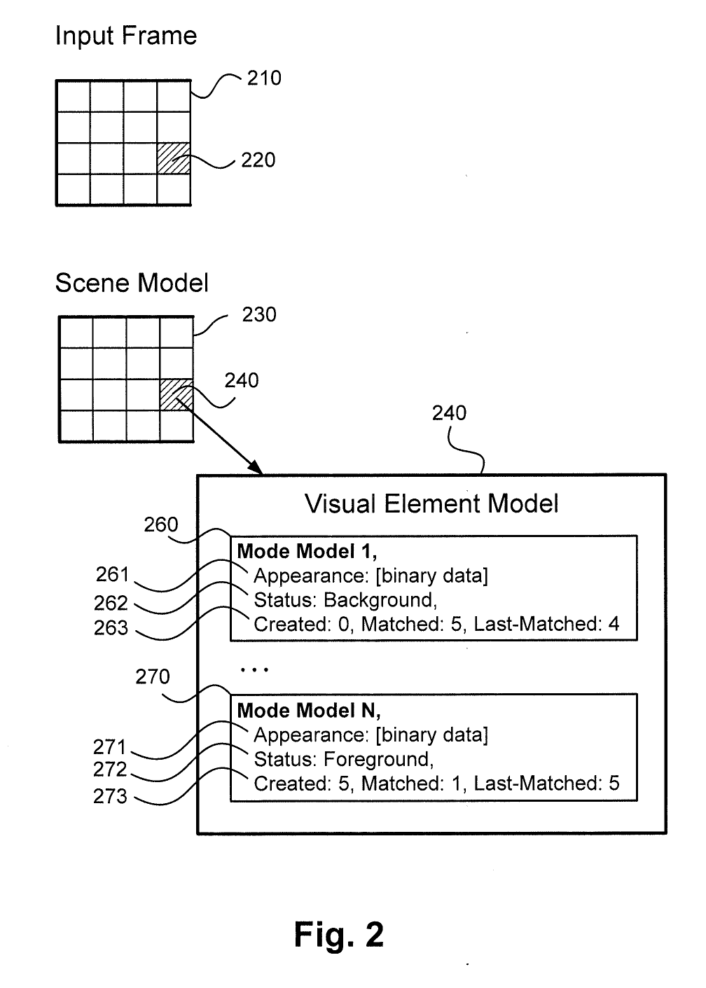

The method of updating a visual element model of a scene model may be implemented using the computer system 800 wherein the processes of FIGS. 2 to 7, described herein, may be implemented as one or more software application programs 833 executable within the computer system 800. In particular, the steps of the method of receiving an incoming visual element, classifying mode models, and removing a mode model are effected by instructions 831 (see FIG. 8B) in the software 833 that are carried out within the computer system 800. The software instructions 831 may be formed as one or more code modules, each for performing one or more particular tasks. The software may also be divided into two separate parts, in which a first part and the corresponding code modules performs the visual element model updating methods and a second part and the corresponding code modules manage a user interface between the first part and the user.

The software 833 is typically stored in the HDD 810 or the memory 806. The software is loaded into the computer system 800 from a computer readable medium, and executed by the computer system 800. Thus, for example, the software 833 may be stored on an optically readable disk storage medium (e.g., CD-ROM) 825 that is read by the optical disk drive 812. A computer readable medium having such software or computer program recorded on it is a computer program product. The use of the computer program product in the computer system 800 preferably effects an apparatus for updating a visual element model in a scene model, which may be utilised for performing foreground/background separation on an image sequence to detect foreground objects in such applications as security surveillance and visual analysis.

In some instances, the application programs 833 may be supplied to the user encoded on one or more CD-ROMs 825 and read via the corresponding drive 812, or alternatively may be read by the user from the networks 820 or 822. Still further, the software can also be loaded into the computer system 800 from other computer readable media. Computer readable storage media refers to any non-transitory tangible storage medium that provides recorded instructions and/or data to the computer system 800 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 801. Examples of transitory or non-tangible computer readable transmission media that may also participate in the provision of software, application programs, instructions and/or data to the computer module 801 include radio or infra-red transmission channels as well as a network connection to another computer or networked device, and the Internet or Intranets including e-mail transmissions and information recorded on Websites and the like.

The second part of the application programs 833 and the corresponding code modules mentioned above may be executed to implement one or more graphical user interfaces (GUIs) to be rendered or otherwise represented upon the display 814. Through manipulation of typically the keyboard 802 and the mouse 803, a user of the computer system 800 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 817 and user voice commands input via the microphone 880.

FIG. 8B is a detailed schematic block diagram of the processor 805 and a “memory” 834. The memory 834 represents a logical aggregation of all the memory modules (including the HDD 809 and semiconductor memory 806) that can be accessed by the computer module 801 in FIG. 8A.

When the computer module 801 is initially powered up, a power-on self-test (POST) program 850 executes. The POST program 850 is typically stored in a ROM 849 of the semiconductor memory 806 of FIG. 8A. A hardware device such as the ROM 849 storing software is sometimes referred to as firmware. The POST program 850 examines hardware within the computer module 801 to ensure proper functioning and typically checks the processor 805, the memory 834 (809, 806), and a basic input-output systems software (BIOS) module 851, also typically stored in the ROM 849, for correct operation. Once the POST program 850 has run successfully, the BIOS 851 activates the hard disk drive 810 of FIG. 8A. Activation of the hard disk drive 810 causes a bootstrap loader program 852 that is resident on the hard disk drive 810 to execute via the processor 805. This loads an operating system 853 into the RAM memory 806, upon which the operating system 853 commences operation. The operating system 853 is a system level application, executable by the processor 805, to fulfil various high level functions, including processor management, memory management, device management, storage management, software application interface, and generic user interface.

The operating system 853 manages the memory 834 (809, 806) to ensure that each process or application running on the computer module 801 has sufficient memory in which to execute without colliding with memory allocated to another process. Furthermore, the different types of memory available in the system 800 of FIG. 8A must be used properly so that each process can run effectively. Accordingly, the aggregated memory 834 is not intended to illustrate how particular segments of memory are allocated (unless otherwise stated), but rather to provide a general view of the memory accessible by the computer system 800 and how such is used.

As shown in FIG. 8B, the processor 805 includes a number of functional modules including a control unit 839, an arithmetic logic unit (ALU) 840, and a local or internal memory 848, sometimes called a cache memory. The cache memory 848 typically includes a number of storage registers 844-846 in a register section. One or more internal busses 841 functionally interconnect these functional modules. The processor 805 typically also has one or more interfaces 842 for communicating with external devices via the system bus 804, using a connection 818. The memory 834 is coupled to the bus 804 using a connection 819.

The application program 833 includes a sequence of instructions 831 that may include conditional branch and loop instructions. The program 833 may also include data 832 which is used in execution of the program 833. The instructions 831 and the data 832 are stored in memory locations 828, 829, 830 and 835, 836, 837, respectively. Depending upon the relative size of the instructions 831 and the memory locations 828-830, a particular instruction may be stored in a single memory location as depicted by the instruction shown in the memory location 830. Alternatively, an instruction may be segmented into a number of parts each of which is stored in a separate memory location, as depicted by the instruction segments shown in the memory locations 828 and 829.

In general, the processor 805 is given a set of instructions which are executed therein. The processor 1105 waits for a subsequent input, to which the processor 805 reacts to by executing another set of instructions. Each input may be provided from one or more of a number of sources, including data generated by one or more of the input devices 802, 803, data received from an external source across one of the networks 820, 802, data retrieved from one of the storage devices 806, 809 or data retrieved from a storage medium 825 inserted into the corresponding reader 812, all depicted in FIG. 8A. The execution of a set of the instructions may in some cases result in output of data. Execution may also involve storing data or variables to the memory 834.

The disclosed visual element model updating arrangements use input variables 854, which are stored in the memory 834 in corresponding memory locations 855, 856, 857. The visual element model updating arrangements produce output variables 861, which are stored in the memory 834 in corresponding memory locations 862, 863, 864. Intermediate variables 858 may be stored in memory locations 859, 860, 866 and 867.

Referring to the processor 805 of FIG. 8B, the registers 844, 845, 846, the arithmetic logic unit (ALU) 840, and the control unit 839 work together to perform sequences of micro-operations needed to perform “fetch, decode, and execute” cycles for every instruction in the instruction set making up the program 833. Each fetch, decode, and execute cycle comprises:

(a) a fetch operation, which fetches or reads an instruction 831 from a memory location 828, 829, 830;

(b) a decode operation in which the control unit 839 determines which instruction has been fetched; and

(c) an execute operation in which the control unit 839 and/or the ALU 840 execute the instruction.

Thereafter, a further fetch, decode, and execute cycle for the next instruction may be executed. Similarly, a store cycle may be performed by which the control unit 839 stores or writes a value to a memory location 832.

Each step or sub-process in the processes of FIGS. 2 to 7 is associated with one or more segments of the program 833 and is performed by the register section 844, 845, 847, the ALU 840, and the control unit 839 in the processor 805 working together to perform the fetch, decode, and execute cycles for every instruction in the instruction set for the noted segments of the program 833.

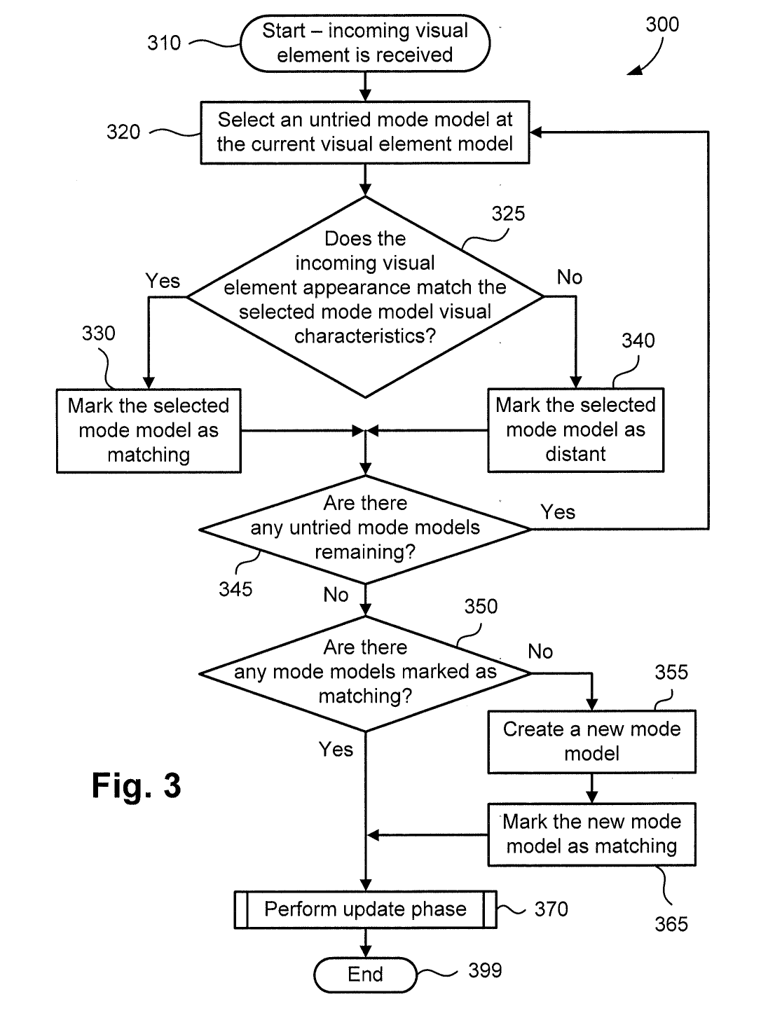

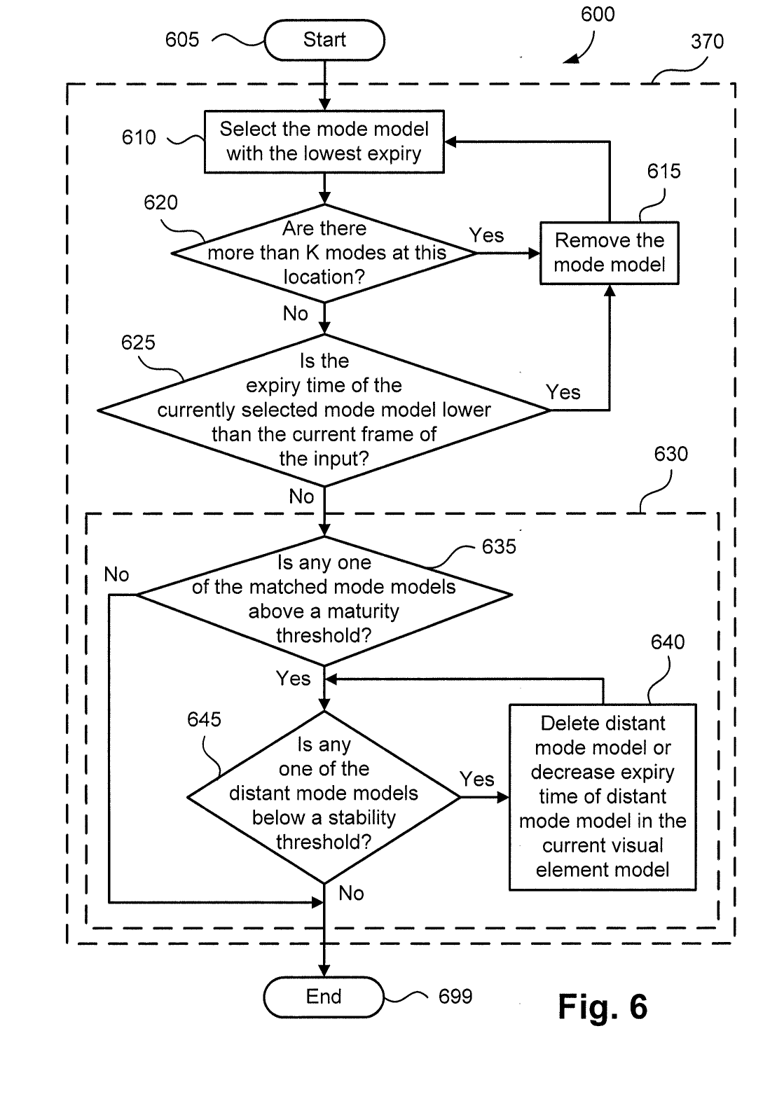

The method of updating a visual element model in a scene model may alternatively be implemented in dedicated hardware such as one or more gate arrays and/or integrated circuits performing the functions or sub functions of receiving an input visual element, classifying mode models as matching or distant, and removing a distant mode model to update the visual element model. Such dedicated hardware may also include graphic processors, digital signal processors, or one or more microprocessors and associated memories. If gate arrays are used, the process flow charts in FIGS. 3 and 6 are converted to Hardware Description Language (HDL) form. This HDL description is converted to a device level netlist which is used by a Place and Route (P&R) tool to produce a file which is downloaded to the gate array to program it with the design specified in the HDL description.

FIG. 2 depicts a schematic block diagram representation of an input frame 210, and a scene model 230 associated with a scene captured in the input frame 210. The input frame 210 includes a plurality of visual elements, including an exemplary visual element 220. The scene model 230 includes a corresponding plurality of visual element models, including a visual element model 240 corresponding to the position or location of the visual element 220 of the input frame 210. In one arrangement, the scene model 230 is stored in the memory 106 of the camera 100. In another arrangement, the scene model 230 is stored in a memory of a remote server or database. In one implementation, the server or database is coupled to the camera 100 by a communications link. The communications link may include a wired or wireless transmission path and may be a dedicated link, a wide area network (WAN), a local area network (LAN), or other communications network, such as the Internet.

As indicated above, the input frame 210 includes a plurality of visual elements. In the example of FIG. 2, an exemplary visual element in the input frame 210 is visual element 220. The visual element 220 is positioned at a location in the scene 210 corresponding to the visual element model 240 of the scene model 230 associated with the scene captured in the input frame 210. A visual element is the elementary unit at which processing takes place and the visual element is captured by an image sensor such as the photo-sensitive sensor array 115 of the camera 100. In one arrangement, the visual element is a pixel. In another arrangement, the visual element is an 8×8 DCT block. In one arrangement, the processing takes place on the processor 105 of the camera 100. In an alternative arrangement, the processing takes place on a remotely located computing device in real-time or at a later time.

The scene model 230 includes a plurality of visual element models, wherein each visual element model corresponds to a location or position of the scene that is being modelled. An exemplary visual element model in the scene model 230 is the visual element 240. For each input visual element of the input frame 210 that is modelled, a corresponding visual element model is maintained in the scene model 230. In the example of FIG. 2, the input visual element 220 has a corresponding visual element model 240 in the scene model 230. The visual element model 240 includes a set of one or more mode models. In the example of FIG. 2, the visual element model 240 includes a set of mode models that includes mode model 1 260, . . . , mode model N 270.

Each mode model in the example of FIG. 2 stores a representative appearance as a set of visual characteristics 261. In one arrangement, the mode model has a status 262, and temporal characteristics 263. Each visual element model is based on a history of the appearances of the input visual element at the corresponding location. Thus, the visual element model 240 is based on a history of the appearance of the input visual element 220. For example, if there was a flashing neon light, one mode model represents “background—light on”, while another mode model represents “background—light off”, and yet another mode model represents “foreground”, such as part of a passing car. In one arrangement, the mode model visual characteristic 261 is the mean value of the pixel intensity values of the input visual element appearances 220. In another arrangement, the mode model visual characteristic 261 is the median or the approximated median of observed DCT coefficient values for each DCT coefficient of the input visual element 220. In one arrangement, each mode model has a status such as Foreground or Background. For example, mode model 1 260 has a status 262 of background and mode model N 270 has a status 272 of foreground. In one arrangement, the mode model records temporal characteristics, which may include a creation time of the mode model, a count of how many times the mode model has been found to be representative of an input visual element, and a time at which the mode model was most recently found to be representative of an input visual element. In one arrangement, the temporal characteristics also include an expiry time, described later. In the example of FIG. 2, mode model 1 260 includes temporal characteristics 263 that include a creation time of “Frame 0”, a matching count of “5”, and a last-matched time of “Frame 4”. Mode model 2 270 includes temporal characteristics 273 that includes a creation time of “Frame 5”, a matching count of “1”, and a last-matched time of “Frame 5”. The actual characteristics associated with a mode model will depend on the particular application.

FIG. 3 is a flow diagram illustrating a matching process 300 to match an incoming visual element to a mode model in a corresponding visual element model as executed by processor 805. The process 300 starts at a Start step 310, wherein the processor 805 receives an incoming visual element from an input frame of an image sequence. The input frame from the camera 827/100 captures at least a portion of a scene and there is a scene model associated with the scene. At least one visual element in the input frame has an associated visual element model at a corresponding pre-determined position in the scene model. The processor 805 executing the process 300 (as directed by the software application program 833) attempts to match the visual characteristics of the incoming visual element to the visual characteristics of a mode model of a corresponding visual element model stored in the memory 806.

The processor 805 executing the process 300 proceeds from the Start step 310 to step 320, which selects an untried mode model from the visual element model corresponding to the incoming visual element. An untried mode model is a mode model that has not yet been compared to the incoming visual element in the memory 806. The processor 805 executing the method selects a single mode model, say mode model 1 260, from the visual element model 240. Control passes from step 320 to a first decision step 325, wherein the processor 805 determines whether the appearance of the incoming visual element matches the selected mode model from step 320. The visual characteristics stored in the selected mode model 1 261 are compared against the appearance of the incoming visual element 220 to classify the mode model as either matching or distant. One embodiment has the processor 805 classify the mode model by determining a difference between visual characteristics stored in the selected mode model and the appearance of the incoming visual element 220 and comparing the difference to a predetermined threshold. If the appearance of the incoming visual element matches the selected mode model, Yes, control passes from step 325 to step 330. Step 330 marks the selected mode model as a matching mode model. In one implementation, each mode model has an associated status indicating whether the mode model is matching or distant. In such an implementation, step 330 modifies the status associated with the selected mode model to “matching”. Control passes from step 330 to a second decision step 345.

If at step 325 the appearance of the incoming visual element does not match the selected mode model, No, control passes from step 325 to step 340. In step 340, the processor 805 marks the selected mode model as a distant mode model. In the implementation in which each mode model has an associated status indicating whether the mode model is matching or distant, step 340 modifies the status associated with the selected mode model to “distant”. Control passes from step 340 to the second decision step 345.

In step 345, the processor 805 checks whether any untried mode models remain in the visual element model. If the processor 805, in step 345, determines that there is at least one untried mode model still remaining, Yes, control returns from step 345 to step 320 to select one of the remaining untried mode models.

If in step 345, the processor 805 determines that there are no untried mode models remaining, No, then control passes to a third decision step 350 to check whether there are any mode models marked as matching.

If in step 350, the processor 805 determines that there is at least one mode model marked as matching, Yes, then control passes to an update phase 370, before the matching process 300 terminates at an End step 399. Further details regarding the update phase 370 are described with reference to FIG. 6.

Returning to step 350, if step 350 determines that there are no mode models marked as matching, No, then a new mode model is to be created, by the processor 805 executing the application program 833, to represent the incoming visual element 220. Control passes from step 350 to step 355, which creates the new mode model and step 365 marks the new model as matching, before control passes to the update phase 370. Control passes from step 370 to the End step 399 and the matching process 300 terminates.

FIG. 3 illustrates one embodiment for the process 300, wherein the processor 805 selects each mode model in turn to be compared to the incoming visual element and then marks the mode models as one of matching or distant. Other methods for selecting a matching mode model for the incoming visual element may equally be practised. In one alternative embodiment, the process proceeds from step 330 to the update phase in step 370 once a matching mode model has been identified, if only a single matching mode is desired at a visual element model.

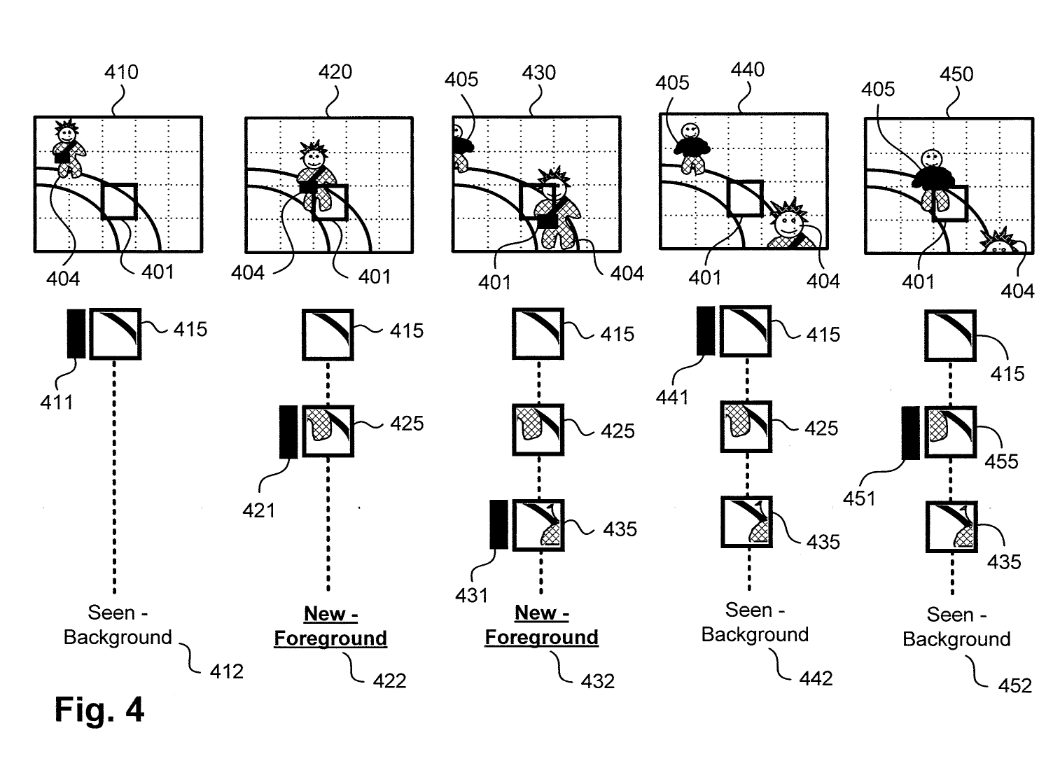

FIG. 4 shows an example of how multiple appearances can be seen at a single visual element location over time resulting in multiple mode models with different temporal properties, and how similar appearances can cause incorrect results. The example of FIG. 4 includes an image sequence that includes successive, but not necessarily consecutive, frames: 410, 420, 430, 440, and 450. Visual element location 401 is present in each of the five frames. In the example of FIG. 4, the image sequence relates to a scene depicting a person 404 walking along a curved path and moving closer to a position of the camera capturing the images in the image sequence. This person 404 is followed by a different person 405 whose general appearance is different but is wearing the same-coloured trousers. In the example of FIG. 4, each image includes a plurality of visual elements arranged in a grid that is five (5) visual elements in a horizontal direction and four (4) visual elements in a vertical direction. Below the frames 410, 420, 430, 440, and 450, we see the mode models (415, 425, 435, 455) stored for location 401, an indication of which mode model is active (411, 421, 431, 441, 451), and an algorithm decision on the content of location 401 (412, 422, 432, 442, 452). The prior art arrangement producing an incorrect result is explained below.

The content of location 401 in the first frame 410 has no foreground, being a section of path. A person 404 is visible but they do not overlap with location 401. Assuming prior initialisation, the active 411 mode model at this time shows this section of path 415, and the algorithm correctly decides that this is previously-seen background 412.

At frame 420 later than frame 410, the person 404 is present at location 401. A section of their trousers are now visible, and a new mode model 425 is stored, alongside the existing background mode model 415. This mode model 425 is active 421, and as it has not been previously seen the algorithm correctly judges it to be new foreground 422.

At frame 430, still later than frame 420, person 404 has moved further down the path and location 401 contains a view of a section of their arm and head. Correspondingly, a new mode model with this content is stored 435 and is active 431. Mode models 415 and 425 are still part of the model for location 401. The algorithm correctly judges that since mode model 435 is new, it is foreground 432. A second person 405 is present in the frame but does not affect the appearance of location 401.

At frame 440 still later than 430, the first person 404 has moved further down the path and the second person 405 is also present in the frame, but neither person affects the appearance of location 401. The content of location 401 is again similar to how it appeared in frame 410, and correspondingly the background mode model 415 is chosen to be active 441. Mode models 425 and 435 remain, which over-models the content of location 401. No new models are created. Since the active 441 mode model 415 containing the attributes of a path has been previously seen, the algorithm correctly judges location 401 to contain background at this time 442.

At frame 450, still later than frame 440, the first person 404 is nearly out of view and does not affect the appearance of location 401. The second person 405 however does affect the appearance of location 401. A section of the second person's trousers are now visible, very similarly to stored mode model 425. Mode model 425 is therefore matched as the attributes of the trousers of the second person 405 is similar to the attributes stored in the previously seen mode model 455. In an exemplary implementation of the prior art, the processor 805 updates the previously seen mode model 455, and the mode model 455 is chosen to be active 451. Since this mode model 455 has previously been seen, the algorithm incorrectly deems it to be recognised background 452. Mode models 415 and 435 remain.

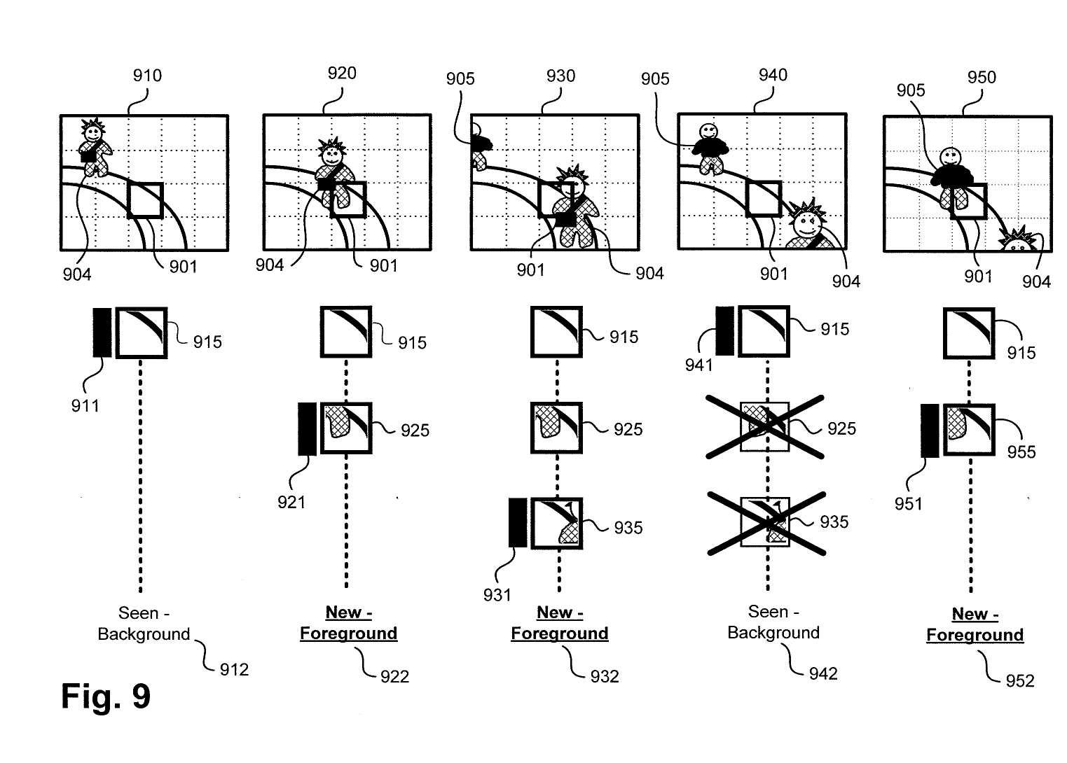

FIG. 9 contrasts with FIG. 4, showing an exemplary implementation of disclosed arrangement for updating a visual element model, describing, firstly, how multiple appearances can be seen at a single visual element location over time resulting in multiple mode models with different temporal properties. Secondly, the exemplary implementation describes how the disclosed arrangement for updating a visual element model can prevent similar appearances from causing incorrect results as FIG. 4 demonstrated. The example of FIG. 9 includes an image sequence that includes successive, but not necessarily consecutive, frames: 910, 920, 930, 940, and 950. Visual element location 901 is present in each of the five frames. Similarly, in the example of FIG. 9, the image sequence relates to a scene depicting a person 904 walking along a curved path and moving closer to a position of the camera capturing the images in the image sequence. This person 904 is followed by a different person 905 whose general appearance is different but is wearing the same-coloured trousers. In the example of FIG. 9, each image includes a plurality of visual elements arranged in a grid that is five (5) visual elements in a horizontal direction and four (4) visual elements in a vertical direction. Below the frames 910, 920, 930, 940, and 950, we see the mode models (915, 925, 935, 955) stored for location 901, an indication of which mode model is active (911, 921, 931, 941, 951), and an algorithm decision on the content of location 901 (912, 922, 932, 942, 952). The arrangement of the exemplary implementation of the disclosed arrangement for updating a visual element model is explained below.

The content of location 901 in the first frame 910 has no foreground, being a section of path. A person 904 is visible but they do not overlap with location 901. Assuming prior initialisation, the active 911 mode model at this time shows this section of path 915, and the algorithm correctly decides that this is previously-seen background 912.

At frame 920 later than frame 910, the person 904 is present at location 901. A section of their trousers are now visible, and a new mode model 925 is stored, alongside the existing background mode model 915. This mode model 925 is active 921, and as the mode model 925 has not been previously seen the algorithm correctly judges it to be new foreground 922.

At frame 930, still later than frame 420, person 904 has moved further down the path and location 901 contains a view of a section of their arm and head. Correspondingly, a new mode model with this content is stored 935 and is active 931. Mode models 915 and 925 are still part of the model for location 901. The algorithm correctly judges that since mode model 935 is new, it is foreground 932. A second person 905 is present in the frame but does not affect the appearance of location 901.

At frame 940 still later than 930, the first person 904 has moved further down the path and the second person 905 is also present in the frame, but neither person affects the appearance of location 901. The content of location 901 is again similar to how it appeared in frame 910, and correspondingly the background mode model 915 is chosen to be active 941. At this point, the disclosed arrangement for updating a visual element model applies to the situation. Mode model 915 is mature and recognised as background, while newer mode models 925 and 935 have not been observed multiple times. The return to mode model 915 indicates that mode models 925 and 935 represented temporary foreground which has moved away, and these mode modes are removed from the model of location 901. Since the active 941 mode model 915 which is the only remaining mode model, has been previously seen, the algorithm correctly judges location 901 to contain background at this time 942.

In the exemplary arrangement, mode models 925 and 935 are removed by the disclosed arrangement for updating a visual element model from the model of location 901 regardless of their properties after a background mode model is detected. The mode models 925 and 935 are deleted because the two mode models are formed after the background model 915 was last detected. In another implementation of the disclosed arrangement for updating a visual element model, the action of the disclosed arrangement is to adjust the normal process by which a mode model is deemed to “age”, accelerating the decision on whether mode models 925 and 935 are kept according to a standard process of model maintenance. In this example they have each been observed only once, so the result is the same and they are removed from the model.

At frame 950, still later than frame 940, the first person 904 is nearly out of view and does not affect the appearance of location 901. The second person 905 however does affect the appearance of location 901. A section of the second person's trousers are now visible, very similarly to mode model 925, but mode model 925 has been removed. Mode model 955 is therefore created, and chosen to be active 951. Since this mode model is new, the algorithm now correctly deems it to be new foreground 952.

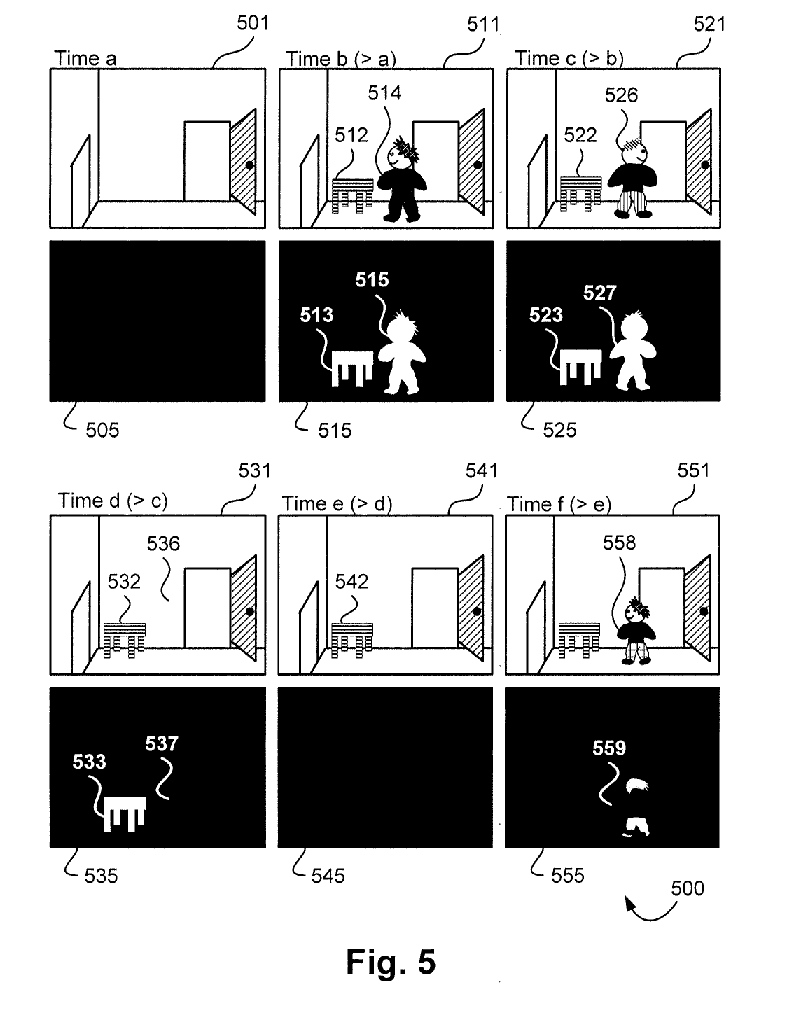

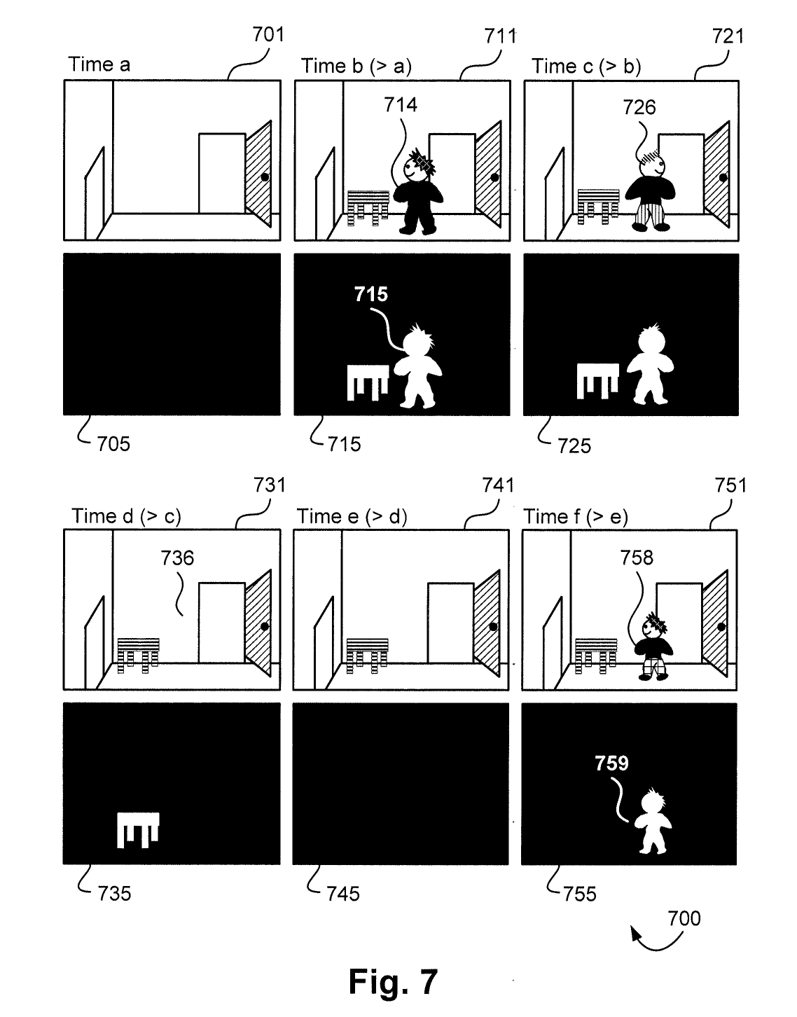

An example showing why the creation of additional mode models is desirable, is illustrated with reference to FIG. 5 and FIG. 7.

FIG. 5 depicts a scene and object detections in that scene over time, showing the problem of over-modelling in a multi-mode system. In particular, FIG. 5 includes images of the scene captured at time a, time b, time c, time d, time e, and time f, wherein f>e>d>c>b>a. That is, the images are successive images in an image sequence, but not necessarily consecutive frames from that image sequence. Each image shown in FIG. 5, 501, 511, 521, 531, 541, 551, has a corresponding output based on the detection of foreground and background for that image, 505, 515, 525, 535, 545, 555. When the scene is empty, and thus has no foreground objects, the scene shows an empty room with an open door.

Initially at time a, an incoming frame 501 shows that the scene is empty and contains no foreground objects. The scene is initialised with at least one matching mode model 260 at each visual element model 240, so the input frame 501 causes no new mode models to be created in memory 806 and all of the matched mode models are considered to be background. Accordingly, an output 505 associated with the input frame 501 is blank, which indicates that no foreground objects were detected in frame 501.

At a later time b, an incoming frame 511 has new elements. A first person 514 brings an object into the scene, wherein the object is a table 512. An output 515 for the frame 511 shows both the first person 514 and the new table 512 as foreground detections 515 and 513, respectively.

At a still later time c, an incoming frame 521 has further different elements. The table seen in frame 511 with a given appearance 512 is still visible in frame 521 with a similar appearance 522. The frame 521 shows a second person 526 that is different from the first person 514 shown in frame 511, but the second person 526 appears at the same location in the scene and with a similar appearance to the first person 514 in frame 511. Based upon their respective temporal characteristics, for example the mode model ages being below a threshold, say 5 minutes, the mode models matching the object 522 at each of the visual element models corresponding to the visual elements of the object 522, are still considered to be foreground, so the object 522 continues to be identified as foreground, represented by foreground detection 523 in an output 525 for the frame 521. The second person 526 mostly has a visual appearance different from the first person 514, so visual elements corresponding to the second person 526 are detected normally through the creation of new mode models, shown as foreground mode model(s) 527 in an output 525 for the frame 521. In part however, the second person 526 shares an appearance with the previous first person 514, but the same rules which allow the appearance of the table 522 to be detected as foreground detection 523 also allow the second person 526 to be detected as foreground 527, even at those locations with similar appearances.

At some point in time d, frame 531 has no person visible in the scene, so the background 536 is visible at the location in the scene previously occupied by the first person 514 and the second person 526. In frame 531, the table is still visible 532, so that an output 535 for the frame 531 shows foreground at a location 533 corresponding to the table 532, but that output 535 shows only background 537 at the location in the scene where the first person 514 and the second person 526 were previously located.

At a still later time e, sufficient time has passed such that mode models corresponding to the appearance of the table 542 in an incoming frame 541 are accepted as background. That is, the age of the mode model that matches the table stored in memory 806 is sufficiently old that the mode model is classified as background. Consequently, the table 542 is no-longer detected as foreground in an output 545 corresponding to the frame 541.

A problem is present at a later time f, in which an incoming frame 551 shows a third person 558 with similar appearance to the first person 514 and the second person 526 at a similar location in the scene to the first person 514 and the second person 526. The same desired behaviour of the system that allowed the table 542 to be treated as background in the output 545 now causes parts of the appearance of the third person 558 to be treated as background also, so that the third person 558 is only partially detected as foreground 559 in an output 555 for the frame 551. At least some of the mode models stored in memory 806 used to match visual elements of the first person 514 and the second person 526 are sufficiently old that those mode models are classified as background. Consequently, at least a part of the third person 558 that is sufficiently similar to corresponding parts of the first person 514 and the second person 526 is incorrectly matched as background and not detected as foreground.

FIG. 6 is a flow diagram 600 illustrating the update process 370 of FIG. 3, which removes mode models from memory 806 of the system. The processing begins at step 605 when control passes from the matching step 340 or when control passes from steps 355, 365 after creating a new mode model in memory 806 and marking the new mode model as matching.

Control passes from step 605 to step 610, wherein the processor 805 selects from the visual element model in memory 806 a mode model with the lowest expiry time. As described above with reference to FIG. 4, the implementation of the expiry time may vary and depends on the application. As indicated above, a visual element model may be configured to have a finite number of mode models. This may be done in light of space and processing constraints. In one example, the number of mode models in a visual element model is a threshold K. The actual value of K will depend on the particular application. Control passes from step 610 to a first decision step 620, wherein the processor 805 determines whether the number of mode models in the current visual element model is more than the value of the threshold K. In one arrangement, K is a fixed value, say 5. If in step 620, the processor 805 determines that there are more than K mode models in the current visual element model, Yes, then control passes from step 620 to step 615, which removes the currently selected mode model having the lowest (earliest) expiry time, regardless of the value of the expiry time of that mode model. That is, irrespective of whether the expiry time of that mode model has passed, the processor 805, in step 615, removes that mode model and control passes back to the selection step 610 to select a mode model having the next-lowest (the next-earliest) expiry time.

In one arrangement, the removal of a mode model from the memory 806 in step 615 is achieved by setting a “skip” bit. In another arrangement, the removal of a mode model from memory 806 in step 615 is achieved by deleting from a linked list an entry that represents the mode model to be removed. In another arrangement, the mode model is stored in a vector, and the removal involves overwriting the mode model information in memory 806 by advancing following entries, then shortening the vector length.

If the processor 805, in step 620, determines that there are not more than K mode models in the current visual element model, No, indicating that the mode model with the lowest (earliest) expiry time in memory 806 does not need to be removed because of the number of mode models, then control passes to a second decision step 625. The second decision step 625 allows the processor 805 to determine whether the expiry time of the currently selected mode model is lower (earlier) than the time of the incoming visual element. If the expiry time is lower than the time of the current incoming visual element, Yes, then the mode model is to be removed from memory 806 and control passes to step 615 to remove that mode model from the visual element model 615. Control then passes from step 615 and returns to step 610 again. If in step 625 the processor 805 determines that the expiry time of the mode model is greater than or equal to the time of the current incoming visual element, No, then the currently selected mode model is to be retained and not removed, and control passes from step 625 to a selective mode model removal stage 630.

The selective mode model removal stage 630 operates after each matched mode model has been evaluated as being above a maturity threshold or not, and each distant mode model has been evaluated as being below a stability threshold or not. Specifically, at 640 within 630, an action is taken on distant mode models below a stability threshold 645, which are in the same visual element model as a matched mode model which is above a maturity threshold 635.

A mode model that satisfies a maturity threshold indicates that the mode model has been seen frequently in the scene. In general, once a mode model is matched frequently in a scene, the mode model is categorised as background. In other words, the maturity threshold determines if a mode model is background or not. However, in another implementation of the an embodiment of the present disclosure, there is one maturity threshold that determines if a mode model is matched with the corresponding visual element model frequently, as well as a temporal threshold that allows the processor 105 to categorise the mode model as one of background or foreground.

In one embodiment, a matched mode model in memory 806 is considered to be above a maturity threshold if the time at which the matched mode model was created is over a predefined threshold (expiry threshold), say 1000 frames. In another embodiment, a matched mode model is considered to be above a maturity threshold if the matched mode model is considered to be background. In one implementation, a matched mode model is considered to be background when the matched mode model has been matched a number of times higher than a constant, say 500 frames. In another implementation, a mode model is considered background if the difference between the current time and the creation time is greater than a threshold, say 5 minutes. In another implementation, the matched mode model is considered to be above a maturity threshold if the matched mode model has been matched a number of times, wherein the number of times is higher than a constant, say 1000 times. In another implementation, the matched mode model is considered to be above a maturity threshold if predefined criteria, such as a predefined combination of the above tests, are met, say 1000 times in the previous 5 minutes.

In one embodiment, a distant mode model is considered to be below a stability threshold if the distant mode model is not above a maturity threshold. In another embodiment, a distant mode model in memory 806 is considered to be below a stability threshold if the difference between the time at which the distant mode model was created and the current time is lower than a predetermined threshold (expiry threshold), say 5 minutes. In another implementation, a mode model is considered to be below a stability threshold if the distant mode model is considered to be foreground. In another implementation, a mode model is considered to be below a stability threshold if the distant mode model has been matched fewer than a given number of times, say 50. In another implementation, a mode model is considered to be below a stability threshold if a predefined combination of the above tests is met, say if the mode model has been matched fewer than 50 times but only if the difference between the time at which the mode model was created and the current time is also less than 1 minute.

Thus, in the same vein as the maturity threshold, the stability threshold determines if a mode model is to be categorised a background or foreground by the processor 105. Thus, the maturity threshold and the stability threshold may be the same temporal threshold. Nevertheless, in another implementation, a stability threshold that determines if a mode model occurs infrequently is provided, as well as another temporal threshold that allows the mode model to be categorised as being foreground or background.

In another embodiment, the maturity threshold and the stability threshold are relative to each other and, having regard to a pair of matched model and distant mode model, the matched mode model in memory 806 is considered to be above a maturity threshold and the distant mode model is considered to be below a stability threshold if the difference between the time at which the matched mode model was created and the time at which a distant mode model was created is above a predetermined threshold, say 5 minutes. In another embodiment, a matched mode model is considered to be above a maturity threshold and a distant mode model is considered to be below a stability threshold if the difference between the number of times that the matched mode model has been matched and the number of times that a distant mode model has been matched is more than a given number of times, say 60. In other words, the matched mode model has been matched more than a number of times compared to the distant mode model. In another embodiment, a matched mode model is considered to be above a maturity threshold and a distant mode model is considered to be below a stability threshold if a calculated score for the matched mode model depending on some combination of the above criteria, say the difference between the creation time and the current time, expressed in seconds, added to the number of times that the mode has been matched, is larger by a threshold, say 50, than the same calculated score of the combination of the above criteria on a distant mode model at the same visual element.

The first step of the selective mode model removal stage 630 is to examine in step 635 the matched mode models, to determine if any matched mode model is above a maturity threshold, as defined. If no matched mode model is above a maturity threshold, No, then control passes from step 635 to an End step 699 and the process is complete.

If at step 635 at least one matched mode model is determined to be above a maturity threshold, then a check is made on the remaining mode models at the same visual element model to see whether any of the distant mode models in that visual element model are below a stability threshold, say 50 frames 645. If there are no mode models below a stability threshold in the current visual element model, then control passes from step 645 to the End step 699 and the process 600 terminates. If any distant mode models are below a stability threshold, Yes, then control passes from step 645 to step 640, which decreases an expiry time of those distant mode models in the current visual element model.

In one embodiment, the expiry time is made immediate and the distant mode model is removed or deleted in step 640. Alternatively, a separate removal/deletion step, not illustrated, may be practised wherein the removal/deletion step removes those mode models that have an expiry time that has passed. In another embodiment, the expiry time depends on the number of times that the mode model has been matched, and that value is considered to be reduced, say by 2 matches. In another embodiment, a penalty value is stored, and increased, say by 2, to be offset from the expiry time at the next time that it is checked in step 625.

Control passes from step 640 and returns to step 645 to check again whether there is a distant mode model below the stability threshold. In other words, every distant mode model in memory 806 is checked as satisfying the stability threshold 645. The expiry times of the distant mode models that do not satisfy the stability threshold are decreased.

The selective mode model removal stage 630 allows the selective removal of the mode models corresponding to the different people 514 and 526 of FIG. 5, in frames 531 and 541. At those times, when people 524 and 526 are absent from the location 536 the background at 536 is matched, triggering the selective removal of modes corresponding to the people 514 and 526. The selective removal of these mode models prevents the matching problem shown with the partial background match 559 in the output 555 of frame 551. Mode models at the location of the table 512 corresponding to the background as seen in 501 are not matched again after time a in frame 501, as the mode models corresponding to the table 532, and 542 are continually visible until the end of the sequence. Thus, the mode models corresponding to the table are not affected by the selective mode model removal stage 630. This is shown in FIG. 7.

FIG. 7 depicts a scene and the object detections in that scene over time, showing the improvement relative to the example of FIG. 5. As for FIG. 5, FIG. 7 includes images of the scene captured at time a, time b, time c, time d, time e, and time f, wherein f>e>d>c>b>a. That is, the images are successive images in an image sequence, but not necessarily consecutive frames from that image sequence. Each image shown in FIG. 7 has a corresponding output based on the detection of foreground and background for that image. When the scene is empty, and thus has no foreground objects, the scene shows an empty room with an open door.

Initially at time a, an incoming frame 701 shows that the scene is empty and contains no foreground objects. With at least one matching mode model 260 at each visual element model 240, the input frame 701 causes no new mode models to be created in memory 806 and all of the matched mode models are considered to be background 705.

At a later time b, an incoming frame 711 has new elements. A first person 714 brings an object such as a table 712 into the scene. An output 715 for the frame 711 detects both the first person 714 and the new table 712 as foreground detections 715 and 713, respectively.

At a still later time c, an incoming frame 721 received by the processor 805 has further different elements. The table seen in frame 711 with a given appearance 712 is still visible in frame 721 with a similar appearance 722. The frame 721 shows a second person 726 that is different from the first person 714 shown in frame 711, but the second person 726 appears at the same location in the scene and with a similar appearance to the first person 714 in frame 711. Based upon their respective temporal characteristics, for example the mode model ages being below a threshold, say 7 minutes, the element models corresponding to the object 722 are still considered to be foreground, so the object continues to be identified as foreground 723 in the output 725. The second person 726 mostly has a different visual appearance to the first person 714, so visual elements corresponding to the second person 726 are detected normally through the creation of new mode models, shown as foreground mode model(s) 727 in an output 725 for the frame 721. In part however, the second person 726 shares an appearance with the previous first person 714, but the same rules which allow the appearance of the table 722 to be detected 723, also allow the second person 726 to be detected as foreground 727 even at those locations with similar appearances.

At some point in time d, frame 731 shows that there is no person visible in the scene, so the background is visible at the location in the scene previously occupied by the first person 714 and the second person 726. The frame 731 shows that the table is still visible 732, so that an output 735 for the frame 731 shows foreground at a location 733 corresponding to the table 732, but the output 735 shows only background 737 at the location in the scene where the first person 714 and the second person 726 were previously located.

At a still later time e, sufficient time has passed such that mode models corresponding to the appearance of the table 742 in an incoming frame 741 are accepted as background. Consequently, the table 742 is no-longer detected as foreground in an output 745 corresponding to the frame 741.

At a later time f, an incoming frame 751 shows a third person 758 with similar appearance to the first person 714 and the second person 726 at a similar location in the scene to the first person 714 and the second person 726. An output 755 is associated with the frame 751. The output 751 shows the third person 758 detected as foreground 759.

Frames 701, 711, 721, 731, 741, and 751 are the same as frames 501, 511, 521, 531, 541, and 551 of FIG. 5, and the history of the appearances in frames 711, 721, 731, and 741 is the same as before in frames 511, 521, 531, and 541. The outputs 705, 715, 725, 735, and 745 are the same as outputs 505, 515, 525, 535, and 545 from FIG. 5.

The difference between the previous set of incoming frames and the outputs from FIG. 5 and the new set of incoming frames and associated outputs shown in FIG. 7 is in the detection of the third person 758 as foreground 759 in the final output 755. The final incoming frame 751 has the same appearance as was shown in 551, with the appearance of the third person 758. The mode models corresponding to the previous appearances of the people 714 and 726 however, will have been removed at time d 731, when the appearance of the relevant portion of the scene showed the background again 736. This allows the detection of the third person 758 at time f to function exactly as the detection of the first person 714 did, to produce the detection 715.

### INDUSTRIAL APPLICABILITY

The arrangements described are applicable to the computer and data processing industries and particularly for the imaging and surveillance industries.

The foregoing describes only some embodiments of the present invention, and modifications and/or changes can be made thereto without departing from the scope and spirit of the invention, the embodiments being illustrative and not restrictive.

1. A method of updating a visual element model of a scene model associated with an image sequence, the visual element model comprising a set of mode models at a pre-determined location of the scene model, the method comprising the steps of:
receiving an incoming visual element at the pre-determined location of a current frame of the image sequence;
determining that the incoming visual element matches a background model at the pre-determined location in the scene model subsequent to a foreground match at the pre-determined location; and
based on the determining step, deleting at least one foreground model used in the foreground match, the foreground model created after the background model is previously matched at the pre-determined location.

2. A method of updating a visual element model of a scene model associated with a scene captured in an image sequence, the visual element model including a set of mode models for a visual element corresponding to a location of the scene, the method comprising the steps of:
receiving an incoming visual element of a current frame of the image sequence;
for each mode model in the visual element model, classifying the respective mode model as one of a matching mode model and a distant mode model, dependent upon a comparison between an appearance of the incoming visual element and a set of visual characteristics of the respective mode model; and
removing a distant mode model from the visual element model, based upon a first temporal characteristic of a matching mode model exceeding a maturity threshold and a second temporal characteristic of the distant mode model being below a stability threshold.

3. The method according to claim 2, wherein the first temporal characteristic of the matching mode model exceeds the maturity threshold if at least one of the following criteria is satisfied:
(a) a creation time of the matching mode model is greater than an predetermined threshold;
(b) the matching mode model is classified as background; and
(c) the matching mode model has been matched at least a predetermined number of times.

4. The method according to claim 2, wherein the second temporal characteristic of the distant mode model is below the stability threshold if at least one of the following criteria is satisfied:
(a) the distant mode model does not exceed the maturity threshold;
(b) a creation time of the distant mode model is below an predetermined threshold;
(c) the distant mode model is classified as foreground; and
(d) the distant mode model has been matched fewer than a predetermined number of times.

5. The method according to claim 2, wherein the maturity threshold and the stability threshold are relative to each other, and a pair of matching mode model and distant mode model are considered to be above a maturity threshold and below a stability threshold respectively, if their expiry times differ by more than a threshold amount.

6. The method according to claim 2, wherein the maturity threshold and the stability threshold are relative to each other, and the matching mode model is considered to be above a maturity threshold if another mode model has been matched more than a given number of times compared to the matching mode model.

7. The method according to claim 2, wherein the maturity threshold and the stability threshold are relative to each other, and the matching mode model is considered to be above a maturity threshold if a first calculated score depending on a combination of the above criteria on the matching mode model is larger than a second calculated score depending on the combination of the above criteria on the distant mode model at the same visual element.

8. A computer readable non-transitory storage medium having recorded thereon a computer program for directing a processor to execute a method of updating a visual element model of a scene model associated with an image sequence, the visual element model comprising a set of mode models at a pre-determined location of the scene model, the computer program comprising code for performing the steps of:
receiving an incoming visual element at the pre-determined location of a current frame of the image sequence;
determining that the incoming visual element matches a background model at the pre-determined location in the scene model subsequent to a foreground match at the pre-determined location; and
based on the determining step, deleting at least one foreground model used in the foreground match, the foreground model created after the background model is previously matched at the pre-determined location.

9. A computer readable non-transitory storage medium having recorded thereon a computer program for directing a processor to execute a method of updating a visual element model of a scene model associated with a scene captured in an image sequence, the visual element model including a set of mode models for a visual element corresponding to a location of the scene, the computer program comprising code for performing the steps of:
receiving an incoming visual element of a current frame of the image sequence;
for each mode model in the visual element model, classifying the respective mode model as one of a matching mode model and a distant mode model, dependent upon a comparison between an appearance of the incoming visual element and a set of visual characteristics of the respective mode model; and
removing a distant mode model from the visual element model, based upon a first temporal characteristic of a matching mode model exceeding a maturity threshold and a second temporal characteristic of the distant mode model being below a stability threshold.

10. A camera system for capturing an image sequence, the camera system comprising:
a lens system;
a sensor;
a storage device for storing a computer program;
a control module coupled to each of the lens system and the sensor to capture the image sequence; and
a processor for executing the program, the program comprising:
computer program code for receiving an incoming visual element at the pre-determined location of a current frame of the image sequence;
computer program code for determining that the incoming visual element matches a background model at the pre-determined location in the scene model subsequent to a foreground match at the pre-determined location; and
computer program code for, based on the determining step, deleting at least one foreground model used in the foreground match, the foreground model created after the background model is previously matched at the pre-determined location.

11. A camera system for capturing an image sequence, the camera system comprising:
a lens system;
a sensor;
a storage device for storing a computer program;
a control module coupled to each of the lens system and the sensor to capture the image sequence; and
a processor for executing the program, the program comprising:
computer program code for updating a visual element model of a scene model associated with a scene captured in an image sequence, the visual element model including a set of mode models for a visual element corresponding to a location of the scene, the updating including the steps of:
receiving an incoming visual element of a current frame of the image sequence;
for each mode model in the visual element model, classifying the respective mode model as one of a matching mode model and a distant mode model, dependent upon a comparison between an appearance of the incoming visual element and a set of visual characteristics of the respective mode model; and
removing a distant mode model from the visual element model, based upon a first temporal characteristic of a matching mode model exceeding a maturity threshold and a second temporal characteristic of the distant mode model being below a stability threshold.

12. A method of performing video surveillance of a scene by utilizing a scene model associated with the scene, the scene model including a plurality of visual elements, wherein each visual element is associated with a visual element model that includes a set of mode models, the method comprising the steps of:
updating a visual element model of the scene model by:
receiving an incoming visual element of a current frame of the image sequence;
for each mode model in the visual element model, classifying the respective mode model as one of a matching mode model and a distant mode model, dependent upon a comparison between an appearance of the incoming visual element and a set of visual characteristics of the respective mode model; and
removing a distant mode model from the visual element model, based upon a first temporal characteristic of a matching mode model exceeding a maturity threshold and a second temporal characteristic of the distant mode model being below a stability threshold.

13. A method of updating a visual element model of a scene model associated with a scene captured in an image sequence, the visual element model including a plurality of mode models for a visual element corresponding to a location of the scene, each mode model being associated with an expiry time, the method comprising the steps of:
receiving an incoming visual element of a current video frame of the image sequence;
for each mode model in the visual element model, classifying the respective mode model as one of a matching mode model and a distant mode model, based upon a comparison between visual characteristics of the incoming visual element and visual characteristics of the respective mode model; and
reducing the expiry time of an identified distant mode model, dependent upon identifying a matching mode model having a first temporal characteristic exceeding a maturity threshold and identifying a distant mode model having a second temporal characteristic not exceeding a stability threshold, to update the visual element model.

14. The method according to claim 13, wherein the first temporal characteristic of the matching mode model exceeds the maturity threshold if at least one of the following is satisfied:
(a) a creation time of the matching mode model is older than an expiry threshold;
(b) the matching mode model is classified as background; and
(c) the matching mode model has been matched at least a predetermined number of times.

15. The method according to claim 13, wherein the second temporal characteristic of the distant mode model is below the stability threshold if at least one of the following is satisfied:
(a) the matching mode model does not exceed the maturity threshold;
(b) a creation time of the matching mode model is below an expiry threshold;
(c) the matching mode model is classified as foreground; and
(d) the matching mode model has been matched fewer than a predetermined number of times.

16. The method according to claim 13, wherein the maturity threshold and the stability threshold are relative to each other, and a pair of matching mode model and distant mode model are considered to be above a maturity threshold and below a stability threshold respectively if their expiry times differ by more than a threshold amount.

17. The method according to claim 13, wherein the maturity threshold and the stability threshold are relative to each other, and the matching mode model is considered to be above a maturity threshold if another mode model has been matched more than a given number of times compared to the matching mode model.

18. The method according to claim 13, wherein the maturity threshold and the stability threshold are relative to each other, and the matching mode model is considered to be above a maturity threshold if a calculated score depending on some combination of the above tests is larger than a calculated score depending on some combination of the above tests on another mode model at the same visual element.
